(19) United States
(12) Patent Application Publication
(10) Pub. No.: US 2010/0097337 A1
(43) Pub. Date: Apr. 22, 2010

(54) METHOD FOR OPERATING PAGE AND ELECTRONIC DEVICE

(75) Inventors: Wei-Ting Lin, Taipei (TW); Yi-Hsuan Cheng, Taipei (TW); Wen-Chieh Tseng, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/578,597

(22) Filed: Oct. 14, 2009

(30) Foreign Application Priority Data
Oct. 17, 2008 (TW) 97140063

(51) Int. Cl. G06F 3/041; G06F 3/048

(52) U.S. Cl. 345/173; 715/800

(57) ABSTRACT

A method for operating a page and an electronic device are provided. In the method, touch signal is received first via a touch screen. Then, if the time for which the touch signal keeps at a location of the touch screen reaches a preset time is determined. If the time for which the touch signal keeps at the location reaches the preset time, a moving track formed by the touch signal is captured, and a page displayed on the touch screen is operated according to the type of the moving track. In the method, whether the touch signal of the user is responded depends on the time of the touch signal. Consequently, the inconvenience caused by unintentional touch can be avoided, and the user can achieve the operation of the page by simple touch signal.

### CROSS-REFERENCE TO RELATED APPLICATION

This application claims the priority benefit of Taiwan application serial no. 97140063, filed on Oct. 17, 2008. The entirety of the above-mentioned patent application is hereby incorporated by reference herein and made a part of specification.

### BACKGROUND OF THE INVENTION

1. Field of the Invention

The invention relates to a method for operating an electronic device and, more particularly, to a method for operating an electronic device via a touch screen and the applications thereof.

2. Description of the Related Art

With the development of touch control technique, a touch screen with the advantages such as a reasonable price and being uneasy to be damaged makes a good figure in the display market gradually. More and more electronic product manufacturers use the touch screen to replace the conventional screen to be an input and output interface of the electronic products after considering the advantages of the touch screen.

To a user, he or she may operate an electronic product via a touch screen intuitively and easily. However, to most tablet personal computers in the market nowadays, when software related to a touch control function is developed by the manufacturer, in most cases, only a few basic operations such as selecting icons and dragging scroll bars up and down are defined. That is, the user may only achieve limited operations via the touch screen, and he or she still has to operate the electronic product via the cooperation of the mouse.

Taking a mouse or other input devices additionally troubles the user certainly. Besides, if operation is achieved only when a plurality of input devices are used, it is also inconvenient in the actual application.

All these may bring the user negative impressions about the feeling of using the electronic products.

### BRIEF SUMMARY OF THE INVENTION

The invention provides a method for operating a page which allow a user to operate the page on a touch screen with simple gestures, and it also provides a mechanism of preventing unintentional touch.

The invention provides an electronic device for the user to achieve operation on the page with the touch screen disposed at the electronic device directly.

To achieve the above and other objectives, the invention provides a method for operating the page displayed on the touch screen. In the method, touch signal is received first via the touch screen. Then, determine the touch signal to actuate touch control functions of the electronic device. Preferably, the determination is based on whether the touch signal is a trigger signal. The trigger signal is a long-keeping signal which keeps still at a location on the touch screen in a preset time, or a continuously-tapping signal in a preset time. If the trigger signals such as the long-keeping signal or the continuously-tapping signal is determined, a moving track formed by the touch signal following the trigger signal is captured. At last, performing an operation to the page according to the moving track.

It is noticed that said determination can further base on any other preset actions applying on the touch screen, such as a continuously-tapping signal in a preset time or any specific gestures. Otherwise, the operation of the page includes but not limits to change pages, rotate, move, zoom in, zoom out, adjust . . . etc.

In an embodiment of the invention, the operation is rotating the page towards a moving direction corresponding to the moving track.

In an embodiment of the invention, the operation is rotating the page in a preset angle towards the moving direction.

In an embodiment of the invention, the operation is moving the page towards a moving direction corresponding to the moving track.

In an embodiment of the invention, the operation is moving the page in a preset distance towards the moving direction.

In an embodiment of the invention, the operation is zooming in or out the page according to the moving track.

In an embodiment of the invention, the operation includes the content of the page inside a frame.

In an embodiment of the invention, the operation includes a frame with the content of the entire page.

From another aspect, the invention provides an electronic device including a touch screen, a touch time determining module and an operating module. The touch screen is used to display the page and receive the touch signal. The touch time determining module is connected to the touch screen for determining whether the touch signal is a trigger signal. The operating module is connected to the touch screen and the touch time determining module, respectively, for capturing the moving track formed by the touch signal and performing an operation to the page according the moving track when the touch signal is the trigger signal.

In an embodiment of the invention, the trigger signal is a long-keeping signal which keeps still at a location on the touch screen in a preset time, or a continuously-tapping signal in a preset time.

In an embodiment of the invention, the operating module rotates, moves, zooms in, zooms out, and adjusts the page.

In an embodiment of the invention, the operating module rotates the page towards a moving direction corresponding to the moving track.

In an embodiment of the invention, the operating module rotates the page in a preset angle towards the moving direction.

In an embodiment of the invention, the operating module moves the page towards a moving direction corresponding to the moving track.

In an embodiment of the invention, the operating module moves the page in a preset distance towards the moving direction.

In an embodiment of the invention, the operating module zooms in or out the page according to the moving track.

In an embodiment of the invention, the operation includes the content of the page inside a frame.

In an embodiment of the invention, the operation includes a frame with the content of the entire page.

In the invention, when the trigger signal is determined, the corresponding operation is performed on the page displayed on the touch screen according to different moving tracks that formed by the touch signal following the trigger signal. Thus, the reaction to the user's touch signal is fine, unintentional touch can be effectively avoided and the convenience of operating the page is improved a lot.

These and other features, aspects and advantages of the present invention will become better understood with regard to the following description, appended claims, and accompanying drawings.

### BRIEF DESCRIPTION OF THE DRAWINGS

FIG. 1 is a block diagram showing an electronic device in an embodiment of the invention.

FIG. 2 is a flow chart showing the method for operating the page in an embodiment of the invention.

FIG. 3A and FIG. 3B are schematic diagrams showing the operation that a user switches the page with a finger in an embodiment of the invention.

FIG. 4 is a schematic diagram showing the operation that the user moves the page with the finger in an embodiment of the invention.

FIG. 5A and FIG. 5B are schematic diagrams showing the operation that the user rotates the page with the finger in an embodiment of the invention.

FIG. 6A and FIG. 6B are schematic diagrams showing the operation that the user zooms in or out on the page with the finger in an embodiment of the invention.

### DETAILED DESCRIPTION OF THE EMBODIMENTS

Generally, user friendly with the operation interface of an electronic product is important to a consumer. Especially, with a portable electronic device, a user is annoyed in bringing additional input devices, for example, a keyboard, or a stylus. Users are more satisfied with a touch screen disposed on the electronic product to achieve all operation by fingers. Thus, it is important for manufacturers to develop a mechanism which allows the user to operate applications in the electronic product with the touch screen directly. The invention provides a method and an electronic device based on the view above. These and other features, aspects and advantages of the present invention will become better understood with regard to the following description, appended claims, and accompanying drawings.

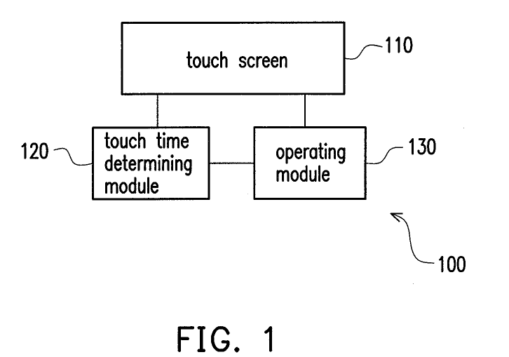

FIG. 1 is a block diagram showing the electronic device in an embodiment of the invention. As shown in FIG. 1, the electronic device 100 includes a touch screen 110, a touch time determining module 120 and an operating module 130. The electronic device 100 may be a mobile phone, a personal digital assistant (PDA), a smart phone, a tablet personal computer or one of other kinds of electronic products, which is not limited. The functions of components in the electronic device 100 are illustrated herein.

In the embodiment, the touch screen 110 may be a resistance-type touch screen or a capacitance-type touch screen. The touch screen 110 may support various functions of operation, and it also may receive touch signal performed by the user with an input tool such as a finger or a touch pen.

The touch time determining module 120 is connected to the touch screen 110, and it is used to determine whether the touch signal is a trigger signal. In the embodiment, the trigger signal is a long-keeping signal which keeps still at a location on the touch screen in a preset time. The location may be any position on the touch screen 110, and the preset time is not limited. Preferably, the preset time may be between 0.2 seconds to 0.5 seconds. In the embodiment, the touch time determining module 120 may be hardware, software having calculating ability or the combination of the software and the hardware, and the mode of realizing the touch time determining module 120 is not limited herein.

The operating module 130 is connected to the touch screen 110 and the touch time determining module 120. According to the determining result generated by the touch time determining module 120, the operating module 130 determines if the page displayed on the touch screen 110 should be operated according to the moving track. The operating module 130 may be the hardware or software having controlling and processing ability or their combination, and the mode of realizing the operating module 130 is not limited herein.

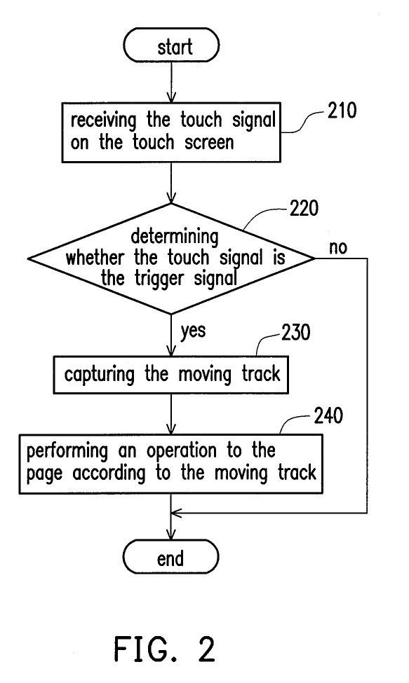

The flow path of operating the electronic device 100 in the invention is illustrated herein. FIG. 2 is a flow chart showing the method for operating the page in an embodiment of the invention. As shown in FIG. 1 and FIG. 2, in the embodiment, a page is displayed by the touch screen 110, and the page may be a web browser page, an image browser page, a file browser page or a document browser page, which is not limited. In other words, after the user starts different browser application in the electronic device 100, the content displayed via the browser application (such as web pages, images, files or documents) may be shown via the touch screen 110.

When the user starts to operate the page displayed on the touch screen 110, he or she may use a finger or a proper input tool to touch the touch screen 110 to generate a touch signal. As shown in step 210, the touch screen 110 may receive the corresponding touch signal. Then, the electronic device 100 determines the touch signal to actuate the touch control functions. In step 220, the touch time determining module 120 determines whether the touch signal is a trigger signal of operating a page. In the embodiment, the trigger signal is a long-keeping signal which keeps still at a location on the touch screen 110 in a preset time (such as 0.5 seconds). In the embodiment, the touch time determining module 120 may start to count the time after the touch screen receives the touch signal. If the user moves his or her finger or the input tool away from the touch screen 110 before the preset time is reached, the flow path of the method for operating the page is finished. That is, to actuate the touch control functions is failed.

However, if the time counted by the touch time determining module 120 reaches the preset time, and the user moves the finger or the proper input tool to generate a track sequentially on the touch screen 110, as shown in step 230. The operating module 130 captures the moving track, and in step 240, the page is performed with an operation according to the type of the moving track. Furthermore, the operating module 130 may obtain the gesture and direction of the moving track and operate the page correspondingly.

As shown in the steps in FIG. 2, only when the time for which the touch signal on the touch screen 110 reaches the preset time, the operating module 130 may operate the page according to the moving track of the touch signal. The step of determine the lasting time of touching ensures that the operating module 130 does not react unintentionally, and this prevents the electronic device 100 from executing a mis-operation of the user.

How the operating module 130 operates the page correspondingly according to the gesture and direction of the moving track is illustrated hereinbelow.

In an embodiment, when the touch screen 110 receives the touch signal, and the touch time determining module 120 determines whether the touch signal is the trigger signal, and the operating module 130 is subsequently determined whether the touch screen 110 displays the page completely. That is, the operating module 130 determines if the whole content of the page is completely displayed on the touch screen 110 according to the size of the page and the size of the touch screen 110, then, the operate module 130 operates the page according to the determining result and the moving track of the touch signal.

Different types of the moving track correspond to various default operations in the electronic device 100. The first type of the moving track is a linear track or a curved track, however, there is not limited in the shape of tracks. When the moving track is the first type, the operating module 130 may obtain the moving direction corresponding to the moving track, and pages are operated and displayed according to different moving directions. Supposing that the first type of track preset by the electronic device 100 is the linear track, the operating module 130 may switch the page to next page when the moving track is the linear track and the moving direction is left, and it may switch the page to the previous page if the moving direction is right. The start point of the moving track may be the same as or different from the position of the location. That is, when the time for which the user's touch reaches the preset time, the moving track is thus determined from the location sequentially or another position with the finger or input tools, which is not limited.

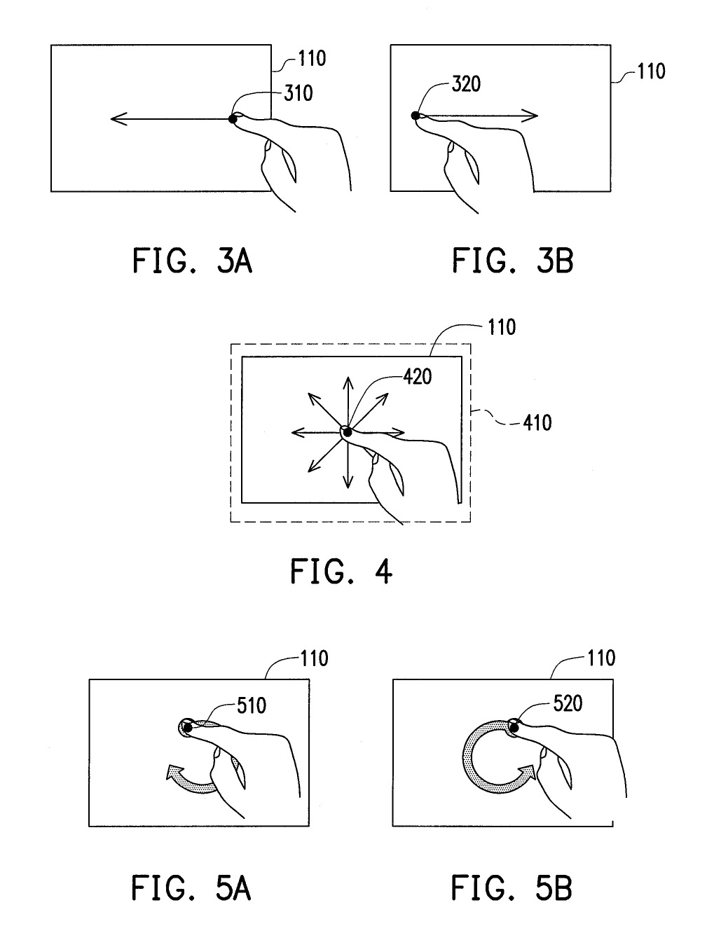

For example, when the size of the page is full screen on the touch screen 110, as shown in FIG. 3A and FIG. 3B, the user may operate the page with a finger. As shown in FIG. 3A, if the user touches the location 310 of the touch screen 110 and it is determined as a long-keeping signal, i.e. the trigger signal, the operating module 130 may switch the page to the previous page when the user moves the finger towards left horizontally. As shown in FIG. 3B, if the user touches the location 310 of the touch screen 110 and it is determined as a long-keeping signal, i.e. the trigger signal, the operating module 130 may switch the page to the next page when the user moves the finger towards right horizontally. To the user, the operation mode rather is the habit of turning pages when he or she reads a book, and it is intuitive and convenient.

Moreover, when the touch screen 110 only displays part area of the page, the user may operate the page to display full page by the following process. First of all, the operating module 130 obtains the moving direction corresponding to the moving track, and determines the direction of the moving direction by comparing with the default directions, i.e. to determine which default direction is the closest to the moving direction. At last, the page is moved according to the determined default direction to adjust the page displayed on the touch screen 110.

FIG. 4 is a schematic diagram showing the operation of the page by moving the finger. As shown in FIG. 4, when the page 410 showed on the touch screen 110 is over-sized, and the moving track determined by the electronic device 100 is the linear track, the operating module 130 may determine which default, direction is the most closest to the moving direction corresponding to the linear moving track. The default directions are not limited but preferably are up, down, left, right, upper left, lower left, upper right and lower right and the like. Following the process above, the page 410 is moved according the determined closest default direction, and this allows the user to move the page 410 by finger directly and browse the whole page 410.

In another embodiment, when the moving track corresponding to the touch signal is the second type of track, the operating module 130 rotates the page towards the moving direction. In the preferred embodiment, the second type of track is a circular curved track, as shown in FIG. 5A. When the long-keeping signal is determined on the location 510, and the moving track is clockwise-circular curve, the operating module 130 may rotate the page by default angles (such as 90 degrees) clockwise. As shown in FIG. 5B, if the long-keeping signal is determined and the moving track is anti-clockwise, the operating module 130 may rotate the page anti-clockwise correspondingly. Thus, the user may rotate the page to make it suitable for watching.

In still another embodiment, after the touch is determined as long-keeping signal, the operating module 130 then determines whether another touch signal is received by the touch screen 110. (The position from which the touch signal is received again may be the same with or different from the position of the location.) If the touch screen 110 receives the touch signal again, the operating module 130 may capture the moving track formed by the second touch signal and determine if the moving track is the third type of track. When the moving track is the third type of track, the page is zoomed in or out corresponding to the moving track. The operating module 130 may determine the zooming ratio according to the length of the moving track, and the third type of track is default in the electronic device 100. The third type of track includes a linear track or a curved track, and the invention is not limited thereto.

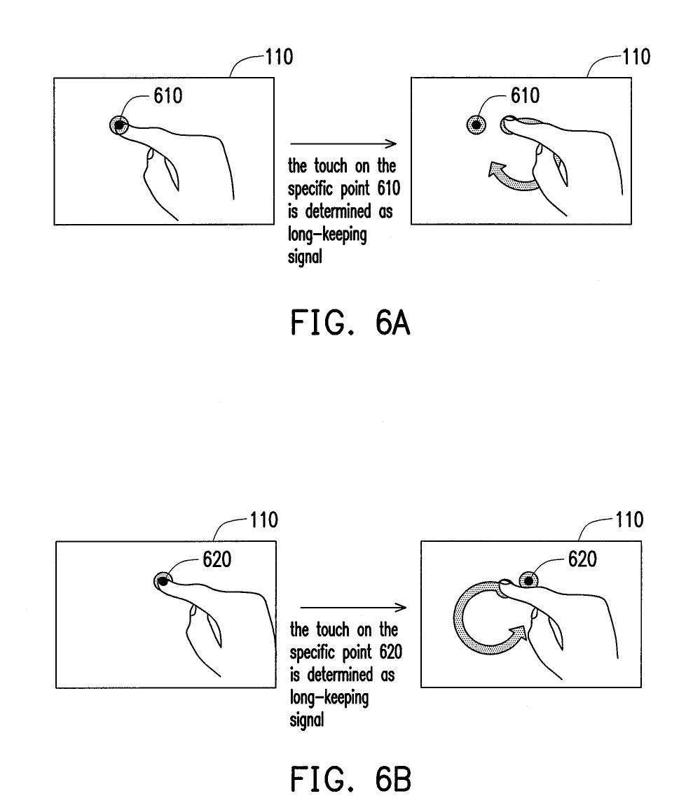

As shown in FIG. 6A, supposing that the third type of track is the curved track, and the long-keeping signal is determined on the location 610, when the clockwise curve is drawn by the user at the position near the location 610 on the touch screen 110, the operating module 130 performs zooming in on the page therewith. Furthermore, if the touch signal is determined as trigger signal as shown in FIG. 6B, when the anti-clockwise curve is drawn by the user at the position near the location 610 on the touch screen 110, the operating module 130 performs zooming out on the page.

Beside the embodiments described above, the trigger signal can be any default actions on the touch screen, such as continuously-tapping in a preset time or any specific gestures. For example, if the touch on the touch screen 110 is determined as continuously-tapping signal, the operating module 130 then determines whether another touch signal is received by the touch screen 110, and performs page operations accordingly. In the preferred embodiment, the preset time for determine the continuously-tapping signal as trigger signal may between 0.2 seconds to 0.5 seconds. However, the preset time for determine the trigger signals is not limited in the present invention.

In the above embodiment, various of page operations are corresponding to the moving tracks of the touch signal, and thus, if the touch time determining module 120 determines that the touch signal on the touch screen 110 is the trigger signal, the operating module 130 may subsequently determine the type of the moving track and the moving direction, and the corresponding page operations is then performed.

In the preferred embodiment as described above, the type of the moving tracks, the moving directions and the page operating actions are all taken as examples, and the invention is not limited thereto. In addition, the operations such as rotating, moving, zooming in, zooming out, and adjusting pages can be performed in not only the content of the page inside a frame but also the entire page within the frame and the content the page.

To sum up, the present invention provides a method for operating the page on the electronic device with touch screen without mis-operation by users. In the present invention, if the user wants to move, switch, rotate, zoom in or zoom out of the page displayed on the touch screen, a trigger signal should be determined first and the following moving tracks corresponding to the touch signal is then determined, and the operations can be performed accordingly. Thus, the user may perform various page operations via simple touch signal, and the mis-operation due to the over-quick reaction or mis-touched of the touch screen is also prevented.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for operating a touch screen, the method comprising:
receiving a touch signal on the touch screen;
determining whether the touch signal is a trigger signal;
capturing a moving track if the touch signal is the trigger signal; and
performing an operation to a page according to the moving track.

2. The method for operating a touch screen according to claim 1, wherein the trigger signal is a long-keeping signal which keeps still at a location on the touch screen in a preset time, or a continuously-tapping signal in a preset time.

3. The method for operating the page according to claim 1, wherein the operation comprises rotate, move, zoom in, zoom out, and adjust the page.

4. The method for operating the page according to claim 3, wherein the operation is rotating the page towards a moving direction corresponding to the moving track.

5. The method for operating the page according to claim 4, wherein the operation is rotating the page in a preset angle towards the moving direction.

6. The method for operating the page according to claim 3, wherein the operation is moving the page towards a moving direction corresponding to the moving track.

7. The method for operating the page according to claim 6, wherein the operation is moving the page in a preset distance towards the moving direction.

8. The method for operating the page according to claim 3, wherein the operation is zooming in or out the page according to the moving track.

9. The method for operating the page according to claim 3, wherein the operation includes the content of the page inside a frame.

10. The method for operating the page according to claim 3, wherein the operation includes a frame with the content of the entire page.

11. An electronic device comprising:
a touch screen for displaying a page and receiving a touch signal;
a touch time determining module, coupled to the touch screen, for determining whether the touch signal is a trigger signal ; and
an operating module, coupled to the touch screen and the touch time determining module, for capturing a moving track and performing an operation to the page according to the moving track when the touch signal is the trigger signal.

12. The electronic device according to claim 11, wherein the trigger signal is a long-keeping signal which keeps still at a location on the touch screen in a preset time, or a continuously-tapping signal in a preset time.

13. The electronic device according to claim 11, wherein the operating module rotates, moves, zooms in, zooms out, and adjusts the page.

14. The electronic device according to claim 13, wherein the operating module rotates the page towards a moving direction corresponding to the moving track.

15. The electronic device according to claim 14, wherein the operating module rotates the page in a preset angle towards the moving direction.

16. The electronic device according to claim 11, wherein the operating module moves the page towards a moving direction corresponding to the moving track.

17. The electronic device according to claim 16, wherein the operating module moves the page in a preset distance towards the moving direction.

18. The electronic device according to claim 12, wherein the operating module zooms in or out the page according to the moving track.

19. The electronic device according to claim 12, wherein the operation includes the content of the page inside a frame.

20. The electronic device according to claim 12, wherein the operation includes a frame with the content of the entire page.
